(19) United States
(12) Patent Application Publication
(10) Pub. No.: US 2024/0156673 A1
(43) Pub. Date: May 16, 2024

(54) Massage and Cellulite Reduction Device

(71) Applicant: Guy Levi, Dania, FL (US)

(72) Inventor: Guy Levi, Dania, FL (US)

(21) Appl. No.: 18/054,462

(22) Filed: Nov. 10, 2022

(51) Int. Cl. A61H 23/02

(52) U.S. Cl. CPC A61H 23/02; A61H 2201/0207; A61H 2201/0228; A61H 2201/10; A61H 2201/1664; A61H 2201/5023; A61H 2207/00

(57) ABSTRACT

A massage and cellulite reduction device is an apparatus that enables the administration of different physical therapies to treat different physical ailments. The present invention also promotes muscle toning and pain relief by applying electrical stimulation. The apparatus includes a handheld housing, percussion therapy (PT) thrusters, a controller, and a portable power source. The handheld housing is designed to be operated singlehandedly for self-treatment of the target body areas. The controller facilitates the operation of the PT thrusters based on user inputs. The portable power source provides the voltage necessary for the electronic and electrical components of the apparatus. Each of the PT thrusters can include a reciprocating piston, a radio frequency (RF) emitter, and an electrical muscle stimulation (EMS) contact. The reciprocating piston enables the application of percussion therapy. The RF emitter enables the radiation of RF waves, while the EMS contact enables the application of electrical pulses.

### FIELD OF THE INVENTION

The present invention relates generally to massage devices and therapeutic systems. More specifically, the present invention provides a massage and cellulite reduction device equipped with different therapeutic options to enhance the therapeutic treatment of a target body area.

### BACKGROUND OF THE INVENTION

Nowadays, many people suffer from different physical ailments that may not require urgent medical treatment but still cause discomfort. For example, muscle soreness after physical activity can cause major discomfort that does not usually need urgent medical care. Likewise, various cosmetic issues such as cellulite can occur due to age, diet, etc., that may not require urgent medical care but is still unpleasant to have. To help alleviate these physical ailments, various therapeutic products have been made available for people to utilize at home. For example, various topical ointments and over-the-counter medicine are available for the user to treat the discomfort and/or the symptoms at home. Further, various therapeutic devices have been made available to help the user target specific areas for treatment. For example, several percussion therapy devices, electrotherapy devices, phototherapy devices, and thermotherapy devices are available to help users treat the areas of the body experiencing the symptoms by using different therapeutic methods. While these devices are useful individually, their combined therapeutic benefits can be more beneficial to help treat the physical ailments. However, most of these devices provide limited range of therapeutic options or fail to deliver the desired therapy to the target body areas where the symptoms are experienced on the body. So, there is a need for a therapeutic device capable of delivering different physical therapies to a target body area.

An objective of the present invention is to provide a massage and cellulite reduction device that can deliver various physical therapies to a target muscle area. The present invention can deliver different physical therapies including, but not limited to, percussion therapy, electrotherapy, phototherapy, thermotherapy, and Radiofrequency (RF) therapy to a target body area for enhanced physical therapy. Another objective of the present invention is to provide a massage and cellulite reduction device that is easy and practical to use by the user. The present invention is designed as a handheld device that can be operated singlehandedly so that the user can self-treat the target body areas using the desired physical therapies. Another objective of the present invention is to provide a massage and cellulite reduction device that can aid in the treatment of cellulite. The present invention can help the user treat the body areas that need cellulite treatment at home. Additional features and benefits of the present invention are further discussed in the sections below.

### SUMMARY OF THE INVENTION

The present invention is a massage and cellulite reduction device. The present invention is designed to deliver different physical therapies to a target body area for enhanced physical treatment. To do so, the present invention includes a handheld housing designed to be operated singlehandedly. The handheld housing is equipped with a pair of percussion therapy (PT) thrusters designed to massage the target body area. Further, each PT thruster is equipped with the means to transmit various electrical and/or radio signals to enhance the physical treatment on the target body area using electrotherapy and Radiofrequency (RF) therapy. Electrotherapy can help with muscle toning on the target body area being massaged by the PT thrusters. RF therapy helps with the cellulite reduction on the target body area being massaged by the PT thrusters. In addition, each PT thruster can be equipped with means to warm and/or cool down the target body areas to administer thermotherapy on the target body areas.

Furthermore, the handheld housing of the present invention can be equipped with other therapeutic systems to administer additional therapies on the target body area. For example, the handheld housing can be equipped with means to emit infrared light to administer phototherapy to further enhance the physical treatment of the target body area. For example, red light can be radiated to the target body area to warm up the target body area. Further, the PT thrusters can also be equipped to emit infrared light onto the target body areas being massaged. The operation of each therapeutic feature can be selectively controller using a user interface integrated into the handheld housing which the user can easily operate. In addition, the present invention is portable for ease of convenience by providing a portable power source that can be recharged as necessary for continuous use. Additional therapeutic and operational features that enhance the operation of the present invention are further discussed in the following sections.

### BRIEF DESCRIPTION OF THE DRAWINGS

FIG. 1 is a top-front perspective view of the present invention.

FIG. 2 is a bottom-rear perspective view of the present invention.

FIG. 3 is a top-rear-exploded perspective view of the present invention.

FIG. 4 is an exploded perspective view of the plurality of Percussion Therapy (PT) thrusters, the reciprocation motor, and the plurality of mechanical linkages of the present invention.

FIG. 5 is a bottom view of the present invention.

FIG. 6 is a schematic view showing the electronic connections and the electrical connections of the present invention, wherein the electronic connections are shown in solid line, and wherein the electrical connections are shown in dotted lines.

### DETAIL DESCRIPTIONS OF THE INVENTION

All illustrations of the drawings are for the purpose of describing selected versions of the present invention and are not intended to limit the scope of the present invention.

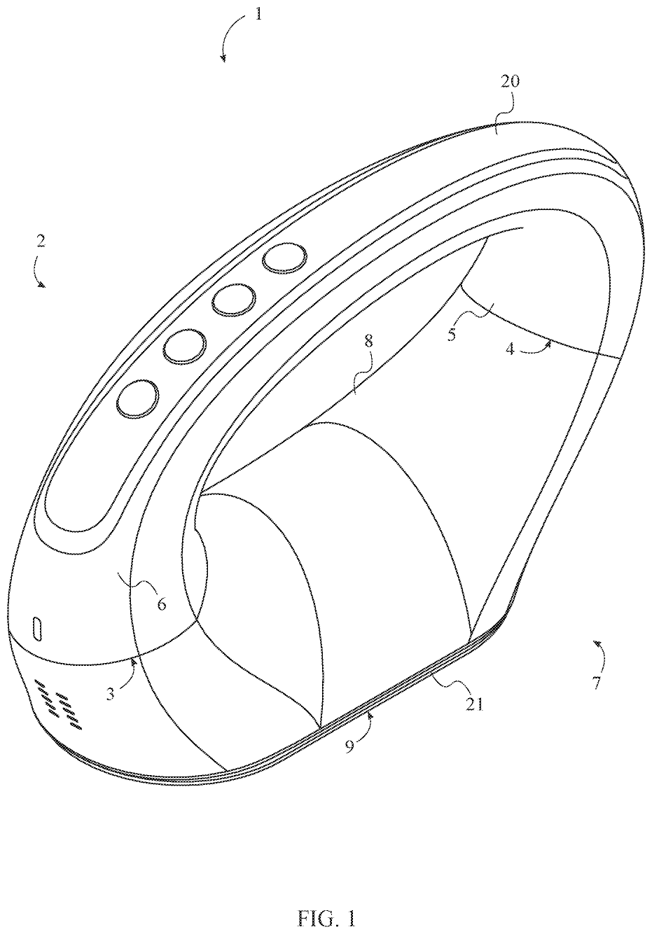

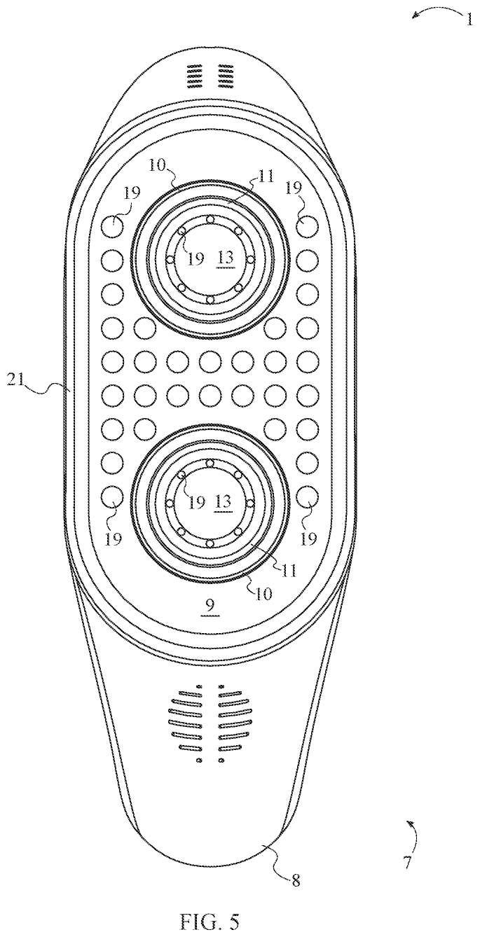

The present invention is a massage and cellulite reduction device that enables the administration of different physical therapies to treat a target body area. As can be seen in FIGS. 1 through 5, the present invention comprises a handheld housing 1, a plurality of percussion therapy (PT) thrusters 11, a controller 17, and a portable power source 18. The handheld housing 1 is designed to be operated singlehandedly so that the user can self-treat the desired body areas. The plurality of PT thrusters 11 is designed to administer percussion therapy to the target body area. The plurality of PT thrusters 11 can also be equipped with other therapeutical systems that can deliver different physical therapies along with percussion therapy. The controller 17 facilitates the automatic operation of the plurality of PT thrusters 11 based on user operational inputs. The portable power source 18 provides the voltage necessary for the operation of the electronic and electrical components of the present invention.

The general configuration of the aforementioned components enables the user to treat different body areas experiencing various physical ailments, such as soreness, cellulite symptoms, etc. The present invention is designed to be operated singlehandedly so that the user can self-treat or have someone else treat the user by utilizing the present invention. As can be seen in FIGS. 1 through 5, the handheld housing 1 comprises a housing handle 2 and a housing base 7. The housing handle 2 is designed to be comfortably held using one hand to securely control the movement of the housing base 7. The housing base 7 enables the administration of the different physical therapies to the target body area by securely containing all the equipment necessary for the operation of every therapeutic system. Further, the plurality of PT thrusters 11 is designed to facilitate the administration of the different physical therapies to the target body area. Accordingly, each of the plurality of PT thrusters 11 comprises a reciprocating piston 12, at least one radio frequency (RF) emitter 14, and at least one electrical muscle stimulation (EMS) contact 15. The reciprocating piston 12 enables the back-and-forth motion of the plurality of PT thrusters 11 to apply percussion therapy onto the target body areas. The at least one RF emitter 14 enables the radiation of RF waves of different wavelengths onto the target body area to reduce cellulite symptoms on the target body area. The at least one EMS contact 15 enables the application of electrical pulses onto the target body area to tighten the muscles around the target body area. Furthermore, the housing base 7 comprises a proximal base face 8 and a distal base face 9 corresponding to the largest surfaces of the housing base 7. The reciprocating piston 12 also comprises a piston contact surface 13 which corresponds to the surface of the reciprocating piston 12 that is in contact with the target body area.

As can be seen in FIGS. 1 through 6, to assemble the present invention, the proximal base face 8 and the distal base face 9 are positioned opposite to each other about the housing base 7. The housing base 7 is preferably shaped as an overall rectangular structure with rounded ends. The distal base face 9 is preferably a rounded or curved face that is in contact with the user's hand. The proximal base face 8 is an overall flat face that is in contact with the user's body. Further, the housing handle 2 is connected onto the distal base face 9 to secure the housing handle 2 to the housing base 7. In addition, the reciprocating piston 12 of each of the plurality of PT thrusters 11 is integrated through the proximal base face 8 and into the housing base 7. The plurality of PT thrusters 11 is also positioned offset amongst each other across the proximal base face 8. This way, each PT thruster is able to operate unobstructed on the proximal base face 8. In addition, the piston contact surface 13 of each PT thruster is positioned external to the housing base 7 so that once the reciprocating piston 12 moves outside the housing base 7, the piston contact surface 13 can strike the target body area. Further, the at least one RF emitter 14 and the at least one EMS contact 15 are mounted within the reciprocating piston 12, adjacent to the piston contact surface 13. This way, once the reciprocating piston 12 extends outwards from the housing base 7 and the piston contact surface 13 strikes the target body area, the at least one EMS contact 15 can transmit the electrical pulse through the piston contact surface 13 to the target body area. Similarly, when the piston contact surface 13 strikes the target body area, the at least one RF emitter 14 can radiate RF waves of different wavelengths onto the target body area. Furthermore, the controller 17 and the portable power source 18 are also mounted within the handheld housing 1. This way, the controller 17 and the portable power source 18 are protected by the handheld housing 1. The controller 17 is electronically connected to the plurality of PT thrusters 11 so that the controller 17 can transmit operational signals for the automatic operation of the plurality of PT thrusters 11. In addition, the portable power source 18 is electrically connected to the controller 17 and the plurality of PT thrusters 11 to transmit the voltage necessary for the operation of the different electrical and electronic components of the present invention.

As can be seen in FIGS. 1 through 5, the handheld housing 1 can be constructed with an ergonomic design to facilitate the holding of the present invention using a single hand. To do so, the handheld housing 1 is shaped with a curved housing handle 2 with a center opening through which the user's fingers can be inserted. Accordingly, the housing handle 2 may comprise a first handle end 3, a second handle end 4, a proximal lateral surface 5, and a distal lateral surface 6. The first handle end 3 and the second handle end 4 correspond to the terminal ends of the housing handle 2. The proximal lateral surface 5 and the distal lateral surface 6 correspond to the largest lateral surfaces of the housing handle 2. To assemble the housing handle 2, the proximal lateral surface 5, and the distal lateral surface 6 are positioned opposite to each other about the housing handle 2. Further, the first handle end 3 and the second handle end 4 are connected onto the distal base face 9 to secure the housing handle 2 to the housing base 7. The first handle end 3 and the second handle end 4 are positioned opposite to each other across the distal base face 9 to leave an opening large enough through which the user's fingers can be inserted. In addition, the proximal lateral surface 5 is positioned offset from the distal base face 9 to form the opening for the user's fingers. Furthermore, the proximal lateral surface 5 is positioned in between the distal lateral surface 6 and the distal base face 9. This way, the housing handle 2 forms a dumbbell-shaped structure with the housing base 7 that is comfortable to handle singlehandedly.

As can be seen in FIGS. 1 through 6, to enable the user to enter operational inputs for the automatic operation of the different therapeutic systems, the present invention may further comprise a user interface 20. The user interface 20 enables the user to enter operational inputs for the different therapeutic systems using different methods. The user interface 20 may provide several buttons and/or dials which enables the user to control different operational aspects of each therapeutic system. For example, the user may selectively activate the desired therapeutic system or adjust the intensity level of the therapeutic system being activated. To enable the control of the different therapeutic systems of the present invention, the user interface 20 is positioned in between the first handle end 3 and the second handle end 4. This way, the user interface 20 can be easily accessed by the same user's hand holding the handheld housing 1. In addition, the user interface 20 is integrated into and along the distal lateral surface 6 to accommodate the necessary buttons, dials, etc., that control the different operational aspects of the therapeutic systems. Further, the controller 17 is electronically connected to the user interface 20 to receive the operational inputs entered by the user via the user interface 20. In other embodiments, the present invention can be provided with a software application wirelessly connected to controller 17 so that the user can remotely control the different therapeutic systems of the present invention.

As can be seen in FIGS. 1 through 5, to enable the unobstructed operation of the plurality of PT thrusters 11, the housing base 7 may further comprise a plurality of guiding sockets 10. The plurality of guiding sockets 10 helps guide the movement of the corresponding reciprocating piston 12 to prevent any malfunction of the plurality of PT thrusters 11. To do so, the plurality of guiding sockets 10 is integrated into the proximal base face 8 to receive the corresponding reciprocating piston 12. Further, the reciprocating piston 12 of each of the plurality of PT thrusters 11 is slidably engaged through a corresponding socket from the plurality of guiding sockets 10. This way, the respective reciprocating piston 12 can securely slide through the housing base 7 through the corresponding socket without obstruction while moving back and forth. The plurality of guiding sockets 10 also protects the electronics connected to the piston contact surface 13 while the reciprocating piston 12 slides out of the housing base 7. In other embodiments, different mechanisms can be used to protect and guide the operation of the plurality of PT thrusters 11.

As can be seen in FIGS. 1 through 6, to enable the reciprocating motion of the plurality of PT thrusters 11, the present invention may further comprise a reciprocation motor 22 and a plurality of mechanical linkages 23. The reciprocation motor 22 is designed to generate a rotational motion to drive the reciprocating motion of each reciprocating piston 12. The plurality of mechanical linkages 23 includes several mechanical linkages that transform the rotational motion from the reciprocation motor 22 to a reciprocating linear motion of the reciprocating piston 12. To do so, the reciprocation motor 22 is mounted within the housing base 7 so that the reciprocation motor 22 is protected by the handheld housing 1. Further, the reciprocation motor 22 is operatively coupled to the reciprocating piston 12 for each of the plurality of PT thrusters 11 by a corresponding linkage from the plurality of mechanical linkages 23, wherein the corresponding linkage is used to convert a rotational motion of the reciprocation motor 22 into a linear back-and-forth motion of the reciprocating piston 12 of each of the plurality of PT thrusters 11.

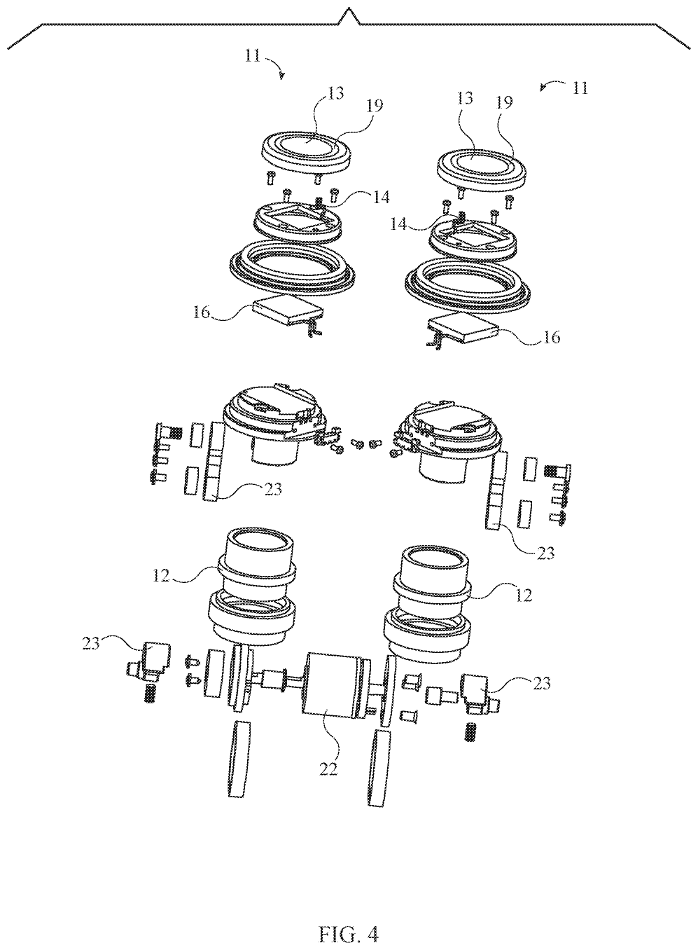

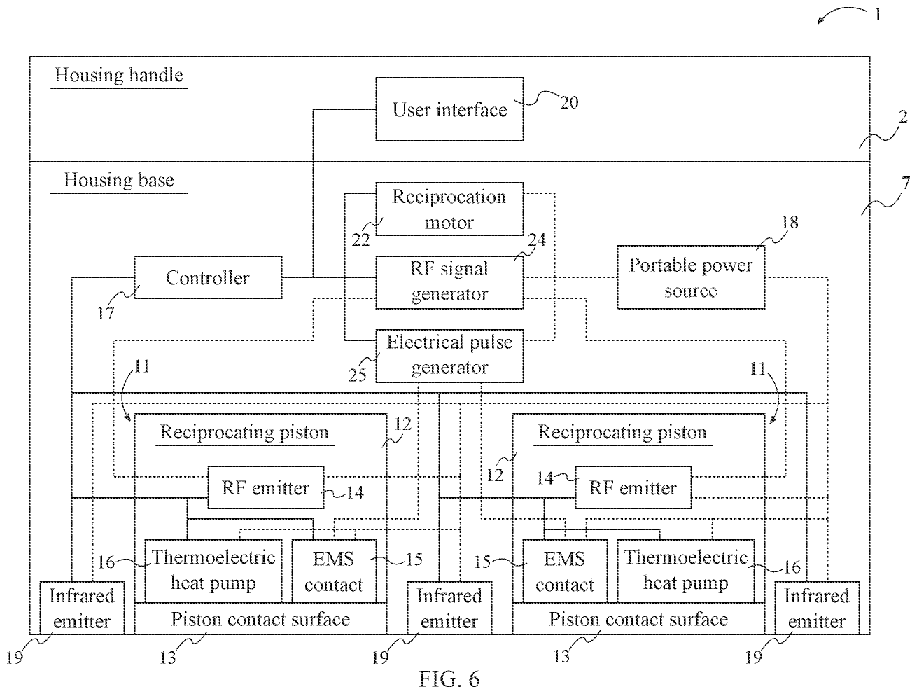

For example, as can be seen in FIGS. 4 and 6, in one embodiment, the plurality of PT thrusters 11 may include a first PT thruster and a second PT thruster. To drive the two PT thrusters, the reciprocation motor 22 can include a first axle and a second axle each rotationally connected to the reciprocation motor 22 on opposite sides of the reciprocation motor 22. In addition, the plurality of mechanical linkages 23 may include a first cam, a second cam, a first connecting rod, and a second connecting rod. So, the first axle is terminally connected to the first cam, while the second axle is terminally connected to the second cam. This way, each cam is rotated by the reciprocation motor 22 via the corresponding axle. The first connecting rod is terminally and pivotally connected to the first cam, while the second connecting rod is also terminally and pivotally connected the second cam. Further, the first connecting rod is terminally connected to the reciprocating piston 12 of the first PT thruster, opposite to the first cam. Similarly, the second connecting rod is also terminally connected to the reciprocating piston 12 of the second PT thruster, opposite to the second cam. This way, as the reciprocation motor 22 rotates the cams via the corresponding axles, the reciprocating piston 12 of the first PT thruster and the reciprocating piston 12 of the second PT thruster are moved in a linear back-and-forth motion by the connecting rods that are pivotally connected to the corresponding cams. Furthermore, the controller 17 is electronically connected to the reciprocation motor 22 to control the automatic operation of the reciprocation motor 22 according to the user's operational inputs. The portable power source 18 is also electrically connected to the reciprocation motor 22 to provide the voltage necessary for the operation of the reciprocation motor 22. In other embodiments, different mechanical connections can be used to convert the rotational motion of the reciprocation motor 22 into a linear back-and-fort motion of each of the plurality of PT thrusters 11.

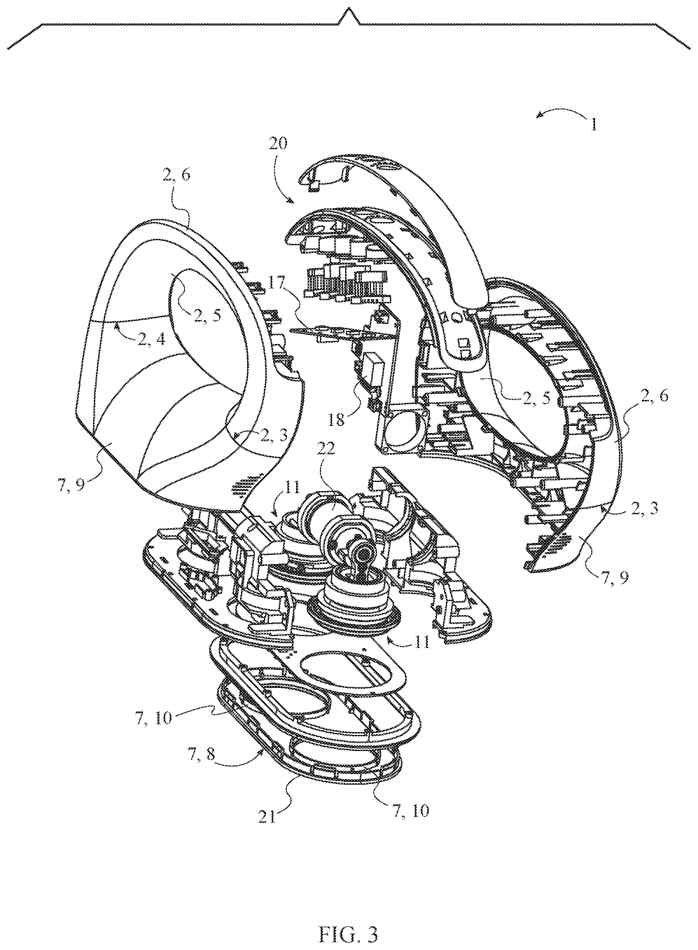

As previously discussed, the at least one RF emitter 14 and the at least one EMS contact 15 are mounted within the respective reciprocating piston 12 so that the body area being targeted is also treated with RF waves and electrical pulses. As can be seen in FIGS. 3 through 6, the at least one RF emitter 14 is oriented towards the piston contact surface 13 so that the radiated RF waves are radiated towards the target body area to treat cellulite symptoms. For example, a radio wave transmitter can be mounted within the reciprocating piston 12, adjacent to the piston contact surface 13, to radiate the RF waves in the desired wavelengths onto the target body area. Similarly, the at least one EMS contact 15 is in electrical communication with the piston contact surface 13 to transmit electrical pulses to the target body area via the piston contact surface 13 to tone the muscles of the target body area. For example, an EMS electrode can be mounted within the reciprocating piston 12 and electrically connected to the piston contact surface 13 so that the electrical pulse transmitted to the piston contact surface 13 is transmitted to the muscles of the target body area. Further, the piston contact surface 13 can be made from a material with good electrical conductivity so that the electrical pulse can be applied to the target body area.

In order to generate the RF waves in the wavelengths necessary to promote the desired therapeutic benefits on the target body areas, the present invention may further comprise an RF signal generator 24. As can be seen in FIG. 6, the RF signal generator 24 is configured to generate RF waves in desired wavelengths to enhance the physical therapy of the cellulite symptoms of the target body area. To do so, the RF signal generator 24 is mounted within the housing base 7 to protect the RF signal generator 24 with the handheld housing 1. Further, the RF signal generator 24 is electrically connected to the at least one RF emitter 14 for each of the plurality of PT thrusters 11. This way, the generated RF signals are transmitted to each RF emitter of the plurality of PT thrusters 11. Furthermore, the controller 17 is electronically connected to the RF signal generator 24 to transmit the operational signals necessary for the automatic operation of the RF signal generator 24. For example, the user can selectively activate the RF signal generator 24 via the user interface 20 or adjust the wavelength of the generated RF signals. Alternatively, the controller 17 may store a predetermined RF wavelength range from which the RF signal generator 24 can generate RF waves. In addition, the portable power source 18 is electrically connected to the RF signal generator 24 to provide the voltage necessary for the operation of the RF signal generator 24.

As can be seen in FIG. 6, in addition to the RF signal generator 24, the present invention may further comprise an electrical pulse generator 25 to control the generation of the electrical pulses to tone the muscles around the target body area. Similar to the RF signal generator 24, the electrical pulse generator 25 is mounted within the housing base 7 to protect the electrical pulse generator 25 with the handheld housing 1. Further, the electrical pulse generator 25 is electrically connected to the at least one EMS contact 15 for each of the plurality of PT thrusters 11. This way, the electrical pulse generated by the electrical pulse generator 25 is transmitted to the EMS contacts of all the plurality of PT thrusters 11. In addition, the controller 17 is electronically connected to the electrical pulse generator 25 to transmit the operational signals necessary for the automatic operation of the electrical pulse generator 25. For example, the user can selectively activate the electrical pulse generator 25 via the user interface 20 or adjust the intensity of the generated electrical pulses. Alternatively, the controller 17 may store a predetermined intensity range from which the electrical pulse generator 25 can generate electrical pulses. Furthermore, the portable power source 18 is electrically connected to the electrical pulse generator 25 to provide the voltage necessary for the operation of the electrical pulse generator 25.

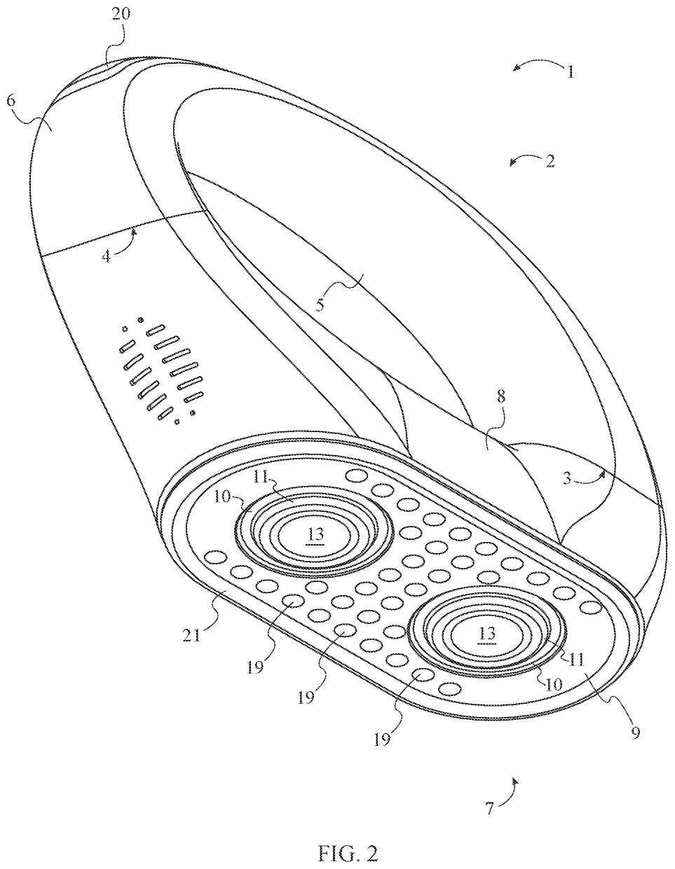

As previously discussed, the present invention can include additional therapeutic systems aside from the ones provided on the plurality of PT thrusters 11. As can be seen in FIGS. 2, 5, and 6, the present invention may further comprise a plurality of infrared emitters 19. The plurality of infrared emitters 19 is designed to emit light over a wide range of wavelengths that have been shown to provide therapeutic benefits. To incorporate the plurality of infrared emitters 19 into the handheld housing 1, the plurality of infrared emitters 19 is integrated into the proximal base face 8 so that once the proximal base face 8 is in contact with or adjacent to the target body area, the plurality of infrared emitters 19 radiate light in target wavelengths onto the target body area. Further, the plurality of infrared emitters 19 is distributed across the proximal base face 8 so that the radiated light reaches a wide body area. In addition, the plurality of PT thrusters 11 is positioned amongst the plurality of infrared emitters 19 so that the plurality of PT thrusters 11 does not obstruct the plurality of infrared emitters 19. Furthermore, the controller 17 is electronically connected to the plurality of infrared emitters 19 so that the controller 17 can transmit operational signals for the automatic operation of the plurality of infrared emitters 19. The portable power source 18 is also electrically connected to the plurality of infrared emitters 19 to provide the voltage necessary for the operation of each of the plurality of infrared emitters 19. Furthermore, the present invention can further include several infrared emitters of the plurality of infrared emitters 19. For example, some infrared emitters of the plurality of infrared emitters 19 can be integrated into the piston contact surface 13. This way, when the piston contact surface 13 hits the target body area, the radiated red light is directly radiated onto the target body area. To do so, the infrared emitters can be arranged into a ring arrangement that is concentric with the circular shape of the piston contact surface 13. In other embodiments, the emitters can be arranged to radiate light on different wavelengths or can be distributed along different areas of the handheld housing 1.

As can be seen in FIGS. 1 through 6, to prevent accidental harm to the user's body from the light radiation from the plurality of infrared emitters 19, the present invention may further comprise an elevation lip 21. The elevation lip 21 is used to offset the proximal base face 8 from the target body area. This enables the radiated light to reach the target body area more evenly and directly. The elevation lip 21 is perimetrically connected onto the proximal base face 8 to secure the elevation lip 21 to the housing base 7. This way, a barrier is also formed around the perimeter of the proximal base face 8 that prevents radiated light from leaking to the surroundings of the target body area that might be sensible to infrared light.

As can be seen in FIGS. 4 and 6, in addition to the plurality of infrared emitters 19, the present invention can also include means to provide thermotherapy for the physical treatment of the target body area. To do so, each of the plurality of PT thrusters 11 may further comprise at least one thermoelectric heat pump 16. The at least one thermoelectric heat pump 16 is designed to either cool down or warm up the piston contact surface 13 to cool down or warm up the target body area being treated. Accordingly, the at least one thermoelectric heat pump 16 is mounted within the reciprocating piston 12, adjacent to the piston contact surface 13. In addition, the at least one thermoelectric heat pump 16 is in thermal communication with the piston contact surface 13. This way, as the at least one thermoelectric heat pump 16 heats up or cools down, the corresponding piston contact surface 13 is also heated up or cooled down, respectively. Furthermore, the controller 17 is electronically connected to the at least one thermoelectric heat pump 16 to transmit the operational signals necessary for the automatic operation of the at least one thermoelectric heat pump 16. For example, the user can selectively activate the at least one thermoelectric heat pump 16 via the user interface 20 or adjust the temperature of the at least one thermoelectric heat pump 16. Alternatively, the controller 17 may store a predetermined temperature range for the at least one thermoelectric heat pump 16 to heat up and/or cool down. In addition, the portable power source 18 is electrically connected to the at least one thermoelectric heat pump 16 to provide the voltage necessary for the operation of the at least one thermoelectric heat pump 16. In other embodiments, additional therapeutic systems can be incorporated into the present invention.

Although the invention has been explained in relation to its preferred embodiment, it is to be understood that many other possible modifications and variations can be made without departing from the spirit and scope of the invention.

What is claimed is:

1. A massage and cellulite reduction device comprising:
a handheld housing;
a plurality of percussion therapy (PT) thrusters;
a controller;
a portable power source;
the handheld housing comprising a housing handle and a housing base;
each of the plurality of PT thrusters comprising a reciprocating piston, at least one radio frequency (RF) emitter, and at least one electrical muscle stimulation (EMS) contact;
the housing base comprising a proximal base face and a distal base face;
the reciprocating piston comprising a piston contact surface;
the proximal base face and the distal base face being positioned opposite to each other about the housing base;
the housing handle being connected onto the distal base face;
the reciprocating piston of each of the plurality of PT thrusters being integrated through the proximal base face and into the housing base;
the plurality of PT thrusters being positioned offset amongst each other across the proximal base face;
the piston contact surface being positioned external to the housing base;
the at least RF emitter and the at least one EMS contact being mounted within the reciprocating piston, adjacent to the piston contact surface;
the controller and the portable power source being mounted within the handheld housing;
the controller being electronically connected to the plurality of PT thrusters; and
the portable power source being electrically connected to the controller and the plurality of PT thrusters.

2. The massage and cellulite reduction device as claimed in claim 1 comprising:
a plurality of infrared emitters;
the plurality of infrared emitters being integrated into the proximal base face;
the plurality of infrared emitters being distributed across the proximal base face;
the plurality of PT thrusters being positioned amongst the plurality of infrared emitters;
the controller being electronically connected to the plurality of infrared emitters; and
the portable power source being electrically connected to the plurality of infrared emitters.

3. The massage and cellulite reduction device as claimed in claim 1 comprising:
the housing handle comprising a first handle end, a second handle end, a proximal lateral surface, and a distal lateral surface;
the proximal lateral surface and the distal lateral surface being positioned opposite to each other about the housing handle;
the first handle end and the second handle end being connected onto the distal base face;
the first handle end and the second handle end being positioned opposite to each other across the distal base face;
the proximal lateral surface being positioned offset from the distal base face; and
the proximal lateral surface being positioned in between the distal lateral surface and the distal base face.

4. The massage and cellulite reduction device as claimed in claim 3 comprising:
a user interface;
the user interface being positioned in between the first handle end and the second handle end;
the user interface being integrated into and along the distal lateral surface; and
the controller being electronically connected to the user interface.

5. The massage and cellulite reduction device as claimed in claim 1 comprising:
an elevation lip; and
the elevation lip being perimetrically connected onto the proximal base face.

6. The massage and cellulite reduction device as claimed in claim 1 comprising:
the housing base further comprising a plurality of guiding sockets;
the plurality of guiding sockets being integrated into the proximal base face; and
the reciprocating piston of each of the plurality of PT thrusters being slidably engaged through a corresponding socket from the plurality of guiding sockets.

7. The massage and cellulite reduction device as claimed in claim 1 comprising:
a reciprocation motor;
a plurality of mechanical linkages;
the reciprocation motor being mounted within the housing base;
the reciprocation motor being operatively coupled to the reciprocating piston for each of the plurality of PT thrusters by a corresponding linkage from the plurality of mechanical linkages, wherein the corresponding linkage is used to convert a rotational motion of the reciprocation motor into a linear back-and-forth motion of the reciprocating piston of each of the plurality of PT thrusters;
the controller being electronically connected to the reciprocation motor; and
the portable power source being electrically connected to the reciprocation motor.

8. The massage and cellulite reduction device as claimed in claim 1 comprising:
the at least one RF emitter being oriented towards the piston contact surface; and
the at least one EMS contact being in electrical communication with the piston contact surface.

9. The massage and cellulite reduction device as claimed in claim 1 comprising:
each of the plurality of PT thrusters further comprising at least one thermoelectric heat pump;
the at least one thermoelectric heat pump being mounted within the reciprocating piston, adjacent to the piston contact surface;
the at least one thermoelectric heat pump being in thermal communication with the piston contact surface;
the controller being electronically connected to the at least one thermoelectric heat pump; and
the portable power source being electrically connected to the at least one thermoelectric heat pump.

10. The massage and cellulite reduction device as claimed in claim 1 comprising:
an RF signal generator;
the RF signal generator being mounted within the housing base;
the RF signal generator being electrically connected to the at least one RF emitter for each of the plurality of PT thrusters;
the controller being electronically connected to the RF signal generator; and
the portable power source being electrically connected to the RF signal generator.

11. The massage and cellulite reduction device as claimed in claim 1 comprising:
an electrical pulse generator;
the electrical pulse generator being mounted within the housing base;
the electrical pulse generator being electrically connected to the at least one EMS contact for each of the plurality of PT thrusters;
the controller being electronically connected to the electrical pulse generator; and
the portable power source being electrically connected to the electrical pulse generator.

12. A massage and cellulite reduction device comprising:
a handheld housing;
a plurality of percussion therapy (PT) thrusters;
a controller;
a portable power source;
the handheld housing comprising a housing handle and a housing base;
each of the plurality of PT thrusters comprising a reciprocating piston, at least one radio frequency (RF) emitter, and at least one electrical muscle stimulation (EMS) contact;
the housing base comprising a proximal base face and a distal base face;
the reciprocating piston comprising a piston contact surface;
the proximal base face and the distal base face being positioned opposite to each other about the housing base;
the housing handle being connected onto the distal base face;
the reciprocating piston of each of the plurality of PT thrusters being integrated through the proximal base face and into the housing base;
the plurality of PT thrusters being positioned offset amongst each other across the proximal base face;
the piston contact surface being positioned external to the housing base;
the at least RF emitter and the at least one EMS contact being mounted within the reciprocating piston, adjacent to the piston contact surface;
the at least one RF emitter being oriented towards the piston contact surface;
the at least one EMS contact being in electrical communication with the piston contact surface;
the controller and the portable power source being mounted within the handheld housing;
the controller being electronically connected to the plurality of PT thrusters; and
the portable power source being electrically connected to the controller and the plurality of PT thrusters.

13. The massage and cellulite reduction device as claimed in claim 12 comprising:
a plurality of infrared emitters;
the plurality of infrared emitters being integrated into the proximal base face;
the plurality of infrared emitters being distributed across the proximal base face;
the plurality of PT thrusters being positioned amongst the plurality of infrared emitters;
the controller being electronically connected to the plurality of infrared emitters; and
the portable power source being electrically connected to the plurality of infrared emitters.

14. The massage and cellulite reduction device as claimed in claim 12 comprising:
the housing handle comprising a first handle end, a second handle end, a proximal lateral surface, and a distal lateral surface;
the proximal lateral surface and the distal lateral surface being positioned opposite to each other about the housing handle;
the first handle end and the second handle end being connected onto the distal base face;
the first handle end and the second handle end being positioned opposite to each other across the distal base face;
the proximal lateral surface being positioned offset from the distal base face; and
the proximal lateral surface being positioned in between the distal lateral surface and the distal base face.

15. The massage and cellulite reduction device as claimed in claim 14 comprising:
a user interface;
the user interface being positioned in between the first handle end and the second handle end;
the user interface being integrated into and along the distal lateral surface; and
the controller being electronically connected to the user interface.

16. The massage and cellulite reduction device as claimed in claim 12 comprising:
an elevation lip;
the housing base further comprising a plurality of guiding sockets;
the elevation lip being perimetrically connected onto the proximal base face;
the plurality of guiding sockets being integrated into the proximal base face; and
the reciprocating piston of each of the plurality of PT thrusters being slidably engaged through a corresponding socket from the plurality of guiding sockets.

17. The massage and cellulite reduction device as claimed in claim 12 comprising:
a reciprocation motor;
a plurality of mechanical linkages;
the reciprocation motor being mounted within the housing base;
the reciprocation motor being operatively coupled to the reciprocating piston for each of the plurality of PT thrusters by a corresponding linkage from the plurality of mechanical linkages, wherein the corresponding linkage is used to convert a rotational motion of the reciprocation motor into a linear back-and-forth motion of the reciprocating piston of each of the plurality of PT thrusters;
the controller being electronically connected to the reciprocation motor; and
the portable power source being electrically connected to the reciprocation motor.

18. The massage and cellulite reduction device as claimed in claim 12 comprising:
each of the plurality of PT thrusters further comprising at least one thermoelectric heat pump;
the at least one thermoelectric heat pump being mounted within the reciprocating piston, adjacent to the piston contact surface;
the at least one thermoelectric heat pump being in thermal communication with the piston contact surface;
the controller being electronically connected to the at least one thermoelectric heat pump; and
the portable power source being electrically connected to the at least one thermoelectric heat pump.

19. The massage and cellulite reduction device as claimed in claim 12 comprising:
an RF signal generator;
the RF signal generator being mounted within the housing base;
the RF signal generator being electrically connected to the at least one RF emitter for each of the plurality of PT thrusters;
the controller being electronically connected to the RF signal generator; and
the portable power source being electrically connected to the RF signal generator.

20. The massage and cellulite reduction device as claimed in claim 12 comprising:
an electrical pulse generator;
the electrical pulse generator being mounted within the housing base;
the electrical pulse generator being electrically connected to the at least one EMS contact for each of the plurality of PT thrusters;
the controller being electronically connected to the electrical pulse generator; and
the portable power source being electrically connected to the electrical pulse generator.
